(19) United States
(12) Patent Application Publication
(10) Pub. No.: US 2004/0046874 A1
(43) Pub. Date: Mar. 11, 2004

(54) Miniaturized photosensing instrumentation system

(76) Inventor: Ming-Kai Tse, Lexington, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/416,876

(22) PCT Filed: Nov. 15, 2001
(86) PCT No.: PCT/US01/44962

(51) Int. Cl. H04N 9/73

(52) U.S. Cl. 348/224.1

(57) ABSTRACT

A portable image analyzing system (100) for capturing and processing sampled images for features of interest in a compact and portable instrument includes an image capture unit (112) and a very small sized processor (122). The processor (122) should be miniaturized to be palm sized or smaller. The image capture unit (112) captures images of the samples (142) within a field of view and the palm sized processor (112), which is operatively communicative with the image capture unit, analyzes features of the image for the predetermined information obtained from the image. Additional features allow communication with remote sites to transfer the predetermined information for viewing or for more powerful analyzing and to further enable local downloading of information and desired software by the user in the field.

### CROSS REFERENCE TO RELATED APPLICATIONS

This application claims priority under 35 U.S.C. §119(e) to provisional patent applications serial Nos. 60/248,897 filed Nov. 15, 2000; 60/287,947 filed May 1, 2001; 60/296,615 filed Jun. 7, 2001; 60/325,572 filed Sep. 28, 2001, the disclosures of which are hereby incorporated by reference.

### STATEMENT REGARDING FEDERALLY SPONSORED RESEARCH OR DEVELOPMENT

N/A

### BACKGROUND OF THE INVENTION

Image analyzing instruments are presently known for analyzing the contents of sample images for features of interest. Because of the necessary processing power required to capture and analyze the image data, these known instruments are large, complex and immobile sets of equipment. As a result, the samples desired to be analyzed must be brought to the site of the instrument which may not be readily accessible, convenient or possible for transporting the sample thereto. Also, these instruments are typically dedicated and customized for use in analyzing one type or family of applications, such as printed output or medical treatment analysis. If the sample requires the application of the instrument to be changed, a trained technician for the instrument must modify and re-program the instrument for such a change at a significant cost in time and expense. Accordingly, due to their large size and lack of flexibility in operation, the widespread use of these instruments has been limited.

It would therefore be advantageous to have an image analysis instrument that is compact and portable for field use in a wide variety of applications. It would also be desirable to have a flexible operating instrument that may be easily modified for use in a variety of applications by the user.

### BRIEF SUMMARY OF THE INVENTION

An image analyzing system in a compact and portable instrument is provided for capturing and analyzing sampled images for features of interest. The image analyzing system includes an image capture unit, a very small sized processor, and a user interface. The image capture unit captures the sampled images and the small sized processor, which is operatively communicative with the image capture unit, analyzes features of the image for predetermined information obtained from the image. The user interface serves as the input/output link between the system and the user. The system may include a personal digital assistant (PDA) as the small sized processor, a color LCD touch screen as the user interface, and a digital camera with a set of optics and an illumination source as the image capture unit.

The small sized processor may also include a transport link and a telecommunications link for transmitting the predetermined information to external devices for further analysis or archival purposes. The transport link may transmit the predetermined information to a personal computer or the like and the telecommunications link may be a wireless link for transmitting the predetermined information to a remote processor.

Other aspects, features and advantages of the present invention are disclosed in the detailed description that follows.

### BRIEF DESCRIPTION OF THE SEVERAL VIEWS OF THE DRAWING

The invention will be more fully understood by reference to the following detailed description of the invention in conjunction with the drawings, of which:

FIGS. 1(a) and 1(b) illustrate image analyzing systems according to embodiments of the present invention;

FIG. 2 illustrates an example of the analysis that may be performed by the system according to an embodiment of the present invention;

FIGS. 3(a) and 3(b) illustrate image analysis systems according to embodiments of the present invention;

FIGS. 4(a), 4(b), and 4(c) illustrate configurations of image analyzing systems according to embodiments of the present invention;

FIG. 5 illustrates a display configuration for measurements, results, and operation selection and status of an image analyzing system according to an embodiment of the present invention;

FIG. 6 illustrates an exemplary display configuration in use for an image analyzing system according to an embodiment of the present invention;

FIGS. 7(a), 7(b), and 7(c) illustrate exemplary set up and result display configuration screens for a dot analysis according to embodiments of the present invention;

FIGS. 8(a), 8(b), and 8(c) illustrate exemplary set up and result display configuration screens for a line analysis according to embodiments of the present invention;

FIGS. 9(a), 9(b), and 9(c) illustrate exemplary setup and result display configuration screens for an area analysis according to an embodiment of the present invention;

FIGS. 10(a), 10(b), 10(c), 10(d), 10(e), 10(f), 10(g), 10(h), 10(i), and 10(j) illustrate exemplary set up and result display configuration screens for a tone reproduction analysis according to embodiment of the present invention; and

FIGS. 11(a), 11(b), 11(c), and 11(d) illustrate further embodiments of image analyzing systems according to embodiments of the present invention.

### DETAILED DESCRIPTION OF THE INVENTION

The embodiments of the present invention utilize the availability of computational or processing power in very small sized processors (VSPs), such as personal digital assistants (PDAs) or smaller sized devices, and the ability to accommodate a full color image capture unit such as a digital camera or a photosensor attachment to provide a wide range of image based analyses using software or hardware processing within one instrument. The VSP should be miniaturized to be palm sized or smaller. The VSP may also provide a graphics user interface (GUI) for viewing the captured image, manipulating the captured image data, and facilitating the use of the VSP as an image processor as well as a normal PDA.

The ability of VSPs such as PDAs to interface with or integrate telecommunication devices such as cell phones allows raw or analyzed image data to be sent or received to and from any location. Additionally, wireless capability, such as the so called “Bluetooth” wireless personal area network (PAN) technology, can be used to provide for data exchange with more sophisticated units local to the PAN of the PDAs to enhance the processing power and telecommunications capability nearby. Being software based, the instrument can be updated as models of PDAs and their derivatives are released. Also, the VSP can provide the captured image and analysis results in a variety of different formats and compressions for compatibility and ease of transmission. For example, the captured images may be saved and retrieved as bitmap (BMP) files, and the analysis results may be saved and retrieved as Word and Excel compatible text files or Access compatible database files. Moreover, there is limited or no set complexities for PDAs that come loaded with the necessary software and plug in modules such as for digital image capture and telecommunications.

The analyses that are provided for in the embodiments of the present invention may include portable analysis of printer or copier performance through full color analysis of the captured images for a wide range of objective image quality attributes including text and graphics. Other applications may include barcode type indicia reading, digital watermark, signature analysis and feature extraction, stereo micro or macro analysis of samples with topographical features, analysis of print media for surface texture, gloss, whiteness or brightness and analysis of images taken in the process of medical treatment or diagnosis (e.g. dermatology and forensics) to name just a few examples.

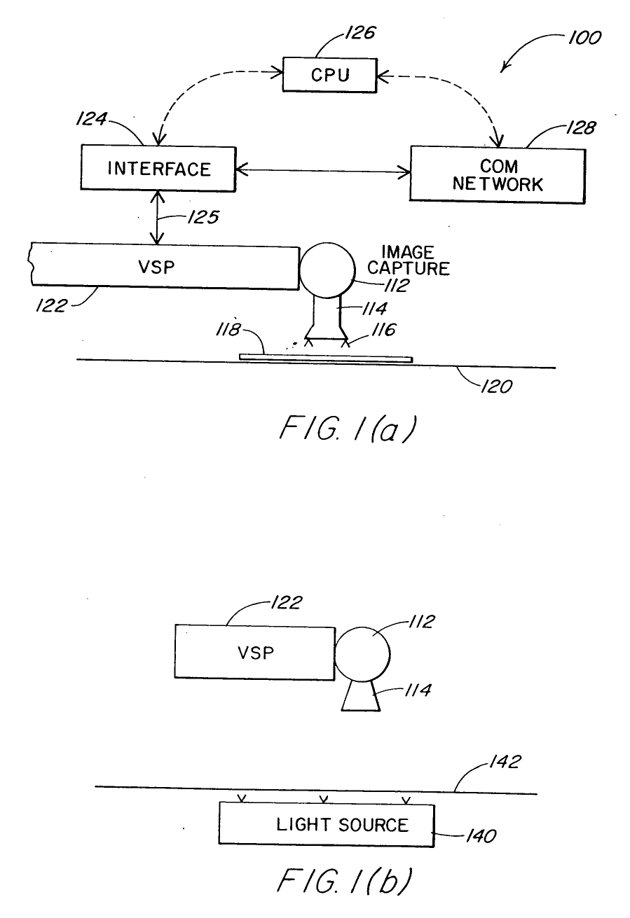

FIG. 1(a) illustrates an image analyzing instrument 100 including a VSP unit 122 and an image capture unit 112 according to an embodiment of the present invention. The image analyzing instrument 100 further includes a lens 114 of a predetermined focal length surrounded by sources of illumination 116. The lens 114 views an illuminated sample image 118 resting on a support 120 within a field of view and provides a captured image signal to the VSP unit 122. The lens is typically a close focus or a macro lens design which is factory set at a predetermined magnification. Optionally, a variable magnification lens is used so that the user according to the intended use may variably set the lens magnification. The VSP unit 122 may be a Casio PDA such as a Cassiopeia model E-125, E-115, EG-800, E-750, NTT DoCoMo G-Fort and other PDAs and palm or pocket sized processors which merely format the sampled image 118 in a predetermined format. The image capture unit 112 may be a digital color camera such as a Casio JK-710DC with 640×480 pixels integrated with the PDA via a compact flash (CF) interface. Some of these VSP units 122 may accommodate or be integrated with the image capture unit 112, for example, the Casio Cassiopeia family which offers a compatible 640×480 CCD camera therewith.

The illumination source may be a narrow band or a broadband light source with a spectral content ranging from UV to visible light to IR according to the desired analysis. For example, samples that exhibit fluorescence can be analyzed when illuminated by an UV illumination source of an appropriate wavelength.

In a further embodiment of the present invention, a transmissive light source 140 may be used in combination with the VSP unit 122 as illustrated in FIG. 1(b). A sample 142 is placed on the transmissive light source 140 so that light is transmitted therefrom toward the image capture unit 112 of the VSP unit 122. Thereby, transparent or translucent samples such overhead transparencies or backlit films can be analyzed.

The VSP unit 122 provides appropriated formatting of the image signal for internal processing and communicates the processed video signal by a link 125 and through an interface 124 from which a CPU 126 may be accessed directly or through a network 128 as will be described in more detail below. The link 125 may be a wired or wireless link and the network 128 may be a telephone network, LAN or another network. The sampled image 118 or 142 may be sent for communication through the interface 124 via the link 125 for more complete processing at a remote location. The VSP unit 122 may include or be part of a cell phone for accessing the CPU 126 through the interface 124.

In one example of an application of the image analyzing instrument 100, the sampled image 118 or 142 may be printed output of printers, copiers or the like where it is desired to evaluate the output quality for optimizing the operation or performance of the equipment, maintenance of the equipment, determination of equipment aging, malfunction or product comparison and other evaluations. The sampled image 118 or 142 may also be any other image that may be computer processed for analysis, record keeping, and/or communication. Some other examples-of sampled images 118 include X-ray images, dental images, dermatology scans, ultrasound scans, barcodes, indicia, and watermarks.

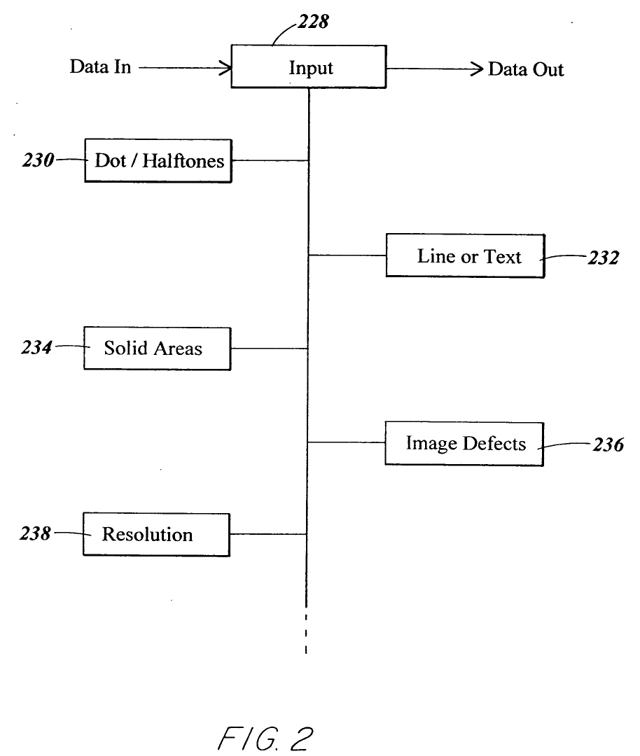

The VSP unit 122 preferably includes a display for indicating the results of the processing and software for performing some or all of the analysis. An example of the processing and software under the control of the VSP unit 122 or the CPU 126 for providing printed output analysis is illustrated in FIG. 2. The analysis may be performed on either the VSP unit 122 or the CPU 126 and begins by inputting the data thereto as shown at step 228. In the present example, such analyses of the printed output may include: dots or so-called halftones for the size, shape, location, density, color and statistics in step 230; lines or text strokes for width, edge blurriness, edge raggedness, contrast, voids, satellites, orientation, density and color at the edge in step 232; solid areas for density, color quality in terms of lightness, hue and saturation, uniformity in density measured in terms of graininess and mottle, and gloss in step 234; image defects such as satellites, voids, haze or background in step 236; resolution in terms of modulation transfer function (MTF) in step 238; and gray scale or color reproduction in terms of tone reproduction, dot percentage coverage and dot gain in step 240.

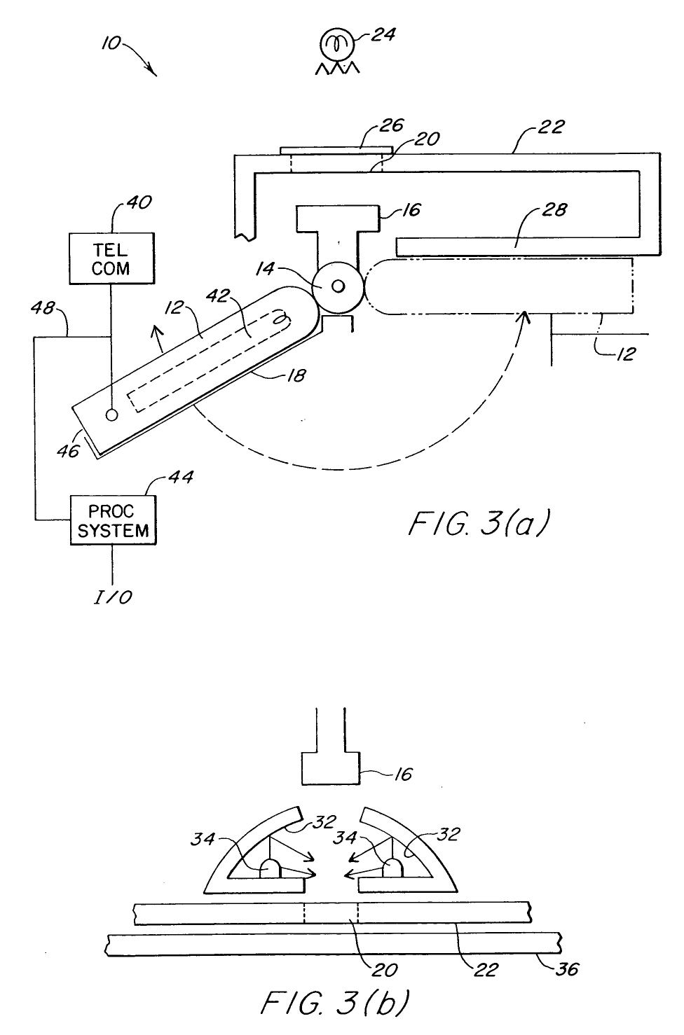

FIG. 3(a) illustrates an image analyzing instrument 10 including a VSP unit 12 and an image capture unit 14 according to another embodiment of the present invention. The image capture unit 14 typically has a lens converter or replacement 16 that provides for close focusing or microscope usage. The image analyzing instrument 10 includes a rest 18 for supporting the VSP unit 12 and aiming the image capture unit 14 upward to view through an aperture 20 of a support 22. A sample 26 may then be placed over the aperture 20 of the support 22 with a light source 24 positioned above the sample 26 to provide back illumination. A shelf 28 may also be included in the support 22 so that the VSP unit 12 may rest in a microscope orientation with the lens 16 looking downward for surface illumination by ambient light, a source or a light distributed around the aperture 20.

In another embodiment of the image analyzing instrument as illustrated in FIG. 3(b), an appropriately shaped housing 30, which has an internal and substantially reflective surface 32, is provided around the aperture 20. An array of light sources 34, such as single colored or multi-colored LEDs, may be placed on the lower or the upper ledge of the housing 30. The color of the reflective surface is typically selected to control or balance the spectral content of the output of the illumination unit. The light sources 34 illuminate a sample 36 through the aperture 20 for viewing by the lens 16 and analysis by the VSP unit 12 and the associated equipment. Various other supports and reflective surfaces may be included to provide compact and portable configurations of the image analyzing instrument as desired. Various illumination configurations and spectral content may also be used, for example, a UV source to stimulate fluorescence in certain samples such as a print output. For analyzing emissive samples such as organic LED (OLED) or polymer LED (PLED) displays, the illumination source may in fact be shut off to reveal the emissive quality of the display in pixel level details.

Referring again to FIG. 3(a), a telecommunications attachment 40 is provided for allowing remote transmission of the captured image from the VSP unit 12 to external devices via a telecommunications link 48 either with or without analysis of the image data. Examples of such external devices include a cell phone or another unit that will respond to data from the VSP unit 12 and forward data thereto in the case of wireless downloads. Alternatively, the VSP unit 12 may be equipped with internal telecommunications circuitry 42, such as a built-in antenna. After remote transmission of the image data, additional analysis and display processing can be accessed by an external processing system 44 from the VSP unit 12 using its interfacing capability over a transport link 46. The external processing system 44 may be a PC or the like and the transport link 46 may be a serial link, such as a universal serial bus (USB), an infrared (IR) link, a compact flash (CF) or similar solid state memory card, or a miniature hard disk drive.

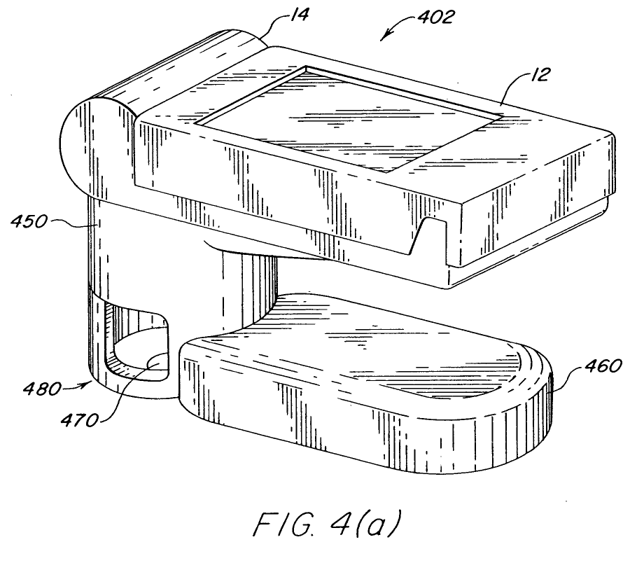

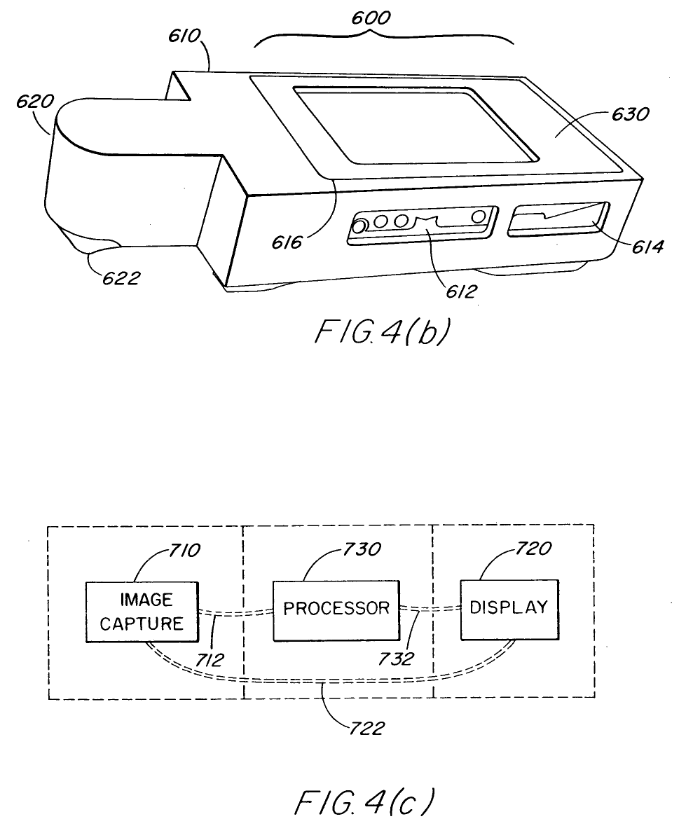

FIG. 4(a) illustrates yet another embodiment of the present invention of an image analyzing instrument 402. In this embodiment, the VSP unit 12 and the image capture unit 14 rest on support portions 450 and 460 with an aperture 470 aligned directly through a hollow opening 480 in the support portion 450.

Still another perspective view of an image analyzing instrument 600 according to an embodiment of the present invention illustrated in FIG. 4(b). The image analyzing instrument 600 includes a body 610 which encompasses an image capture unit 620 and a VSP unit 630. An aperture 622 extends outside the body 610 from the image capture unit 620. Openings 612, 614 and 616 of the body 610 are provided to access controls and the GUI of the VSP unit 620. The image analyzing instrument 600 of the present embodiment is thereby provided as a compact and portable instrument.

In yet other embodiments of the present invention, an image analyzing instrument 700 may include an image capture device 710, a display 720, and a processor 730 that are each separate or integrated in various configurations as illustrated by the dotted lines in FIG. 4(c). For instance, the image capture device 710 may be separate from an integrated configuration of the display 720 and the processor 730. The image capture device 710 may then be designed to be a very small and portable device, such as a pen sized device, that is physically separate from the display 720 and the processor 730, which may be shaped and sized in a credit card like configuration. The image capture device 710 may then be communicatively operative with the integrated display 720 and the processor 730 with a physical link, such as an optical fiber or the like, or through an IR or radio wave link. Various other configurations of separating and integrating these devices can be designed and implemented.

In all of the embodiments, the use of VSP units provide for the compactness and portability of the instrument of the present invention. The size and weight of the instrument may vary depending upon its configuration and it is desired to have the size of the instrument to be small and compact for maximum portability and ease-of-use.

The applications of the image analyzing instrument according to embodiments of the present invention are many. For instance, image quality analysis for text, graphics and barcodes may be performed. Feature extraction and signature analysis may also be conducted. Image quality analysis may include analyzing the size, shape, density, and color cluster statistics of dots; analyzing the width, blurriness, raggedness, density, color, intercolor bleed, and color registration of lines and text; analyzing the density, reflectance, uniformity, color attributes, screen angle, tone reproduction, and dot gain of area measurements; and analyzing background and satellites of image defects. In an image quality analysis, the instrument includes software residing in the VSP unit 12 which is able to store and organize test data of the captured image, plot and print data according to user selected data, perform statistical analysis, and generate reports as specified by the user. The user may create a new database or select and open an existing database via the VSP unit in running a test. The database may have a separate table for the measurement information, such as a dot analysis table, a line analysis table, or an area analysis table. Each measurement set may be combined with sample information to form a record for a table.

Extensive search functions on the database may be provided to the user in selecting the desired data, such as searching by sample name, job number, ink type, printer type, and other test criteria types. The software may also allow extensive plot functions to be performed for displaying user selected test data such as line, bar and scatter plots to name just a few examples. Statistical analysis on user selected data from the database may be performed by the software so that summaries are generated for a measurement, a sample, a test job, a print head type, or an ink type for instance. A report generator may also be provided in the database software so that reports may be printed on selected data for one or more tests. If further analysis is needed the report generator is able to export record sets to a software package residing in an external device via the transport link or the telecommunications link. A package of configurations is made available so that the user may select options and reconfigure the software from the VSP unit. The usability of the instrument is preferably facilitated by allowing the user to select an icon from a list of options or configurations for initiating the desired functionality of the instrument. A list of exemplary software options is provided in Table I.

TABLE I

| Tool | Attributes/Features/Functions |
|---|---|
| Calibration | Density (CMYK) |
| | Color—Lab |
| | Flat field |
| | Spatial |
| | Dot color and density |
| | Background |
| Setup | Dot (threshold; min/max size, positive and |
| | negative dots) |
| | Background (min/max size) |
| | Line (sub sample size, min width, positive or |
| | negative lines) |
| | MTF (lines/mm, no. of patches) |
| | TRC (Dot area %, no. of patches) |
| | Mode (density, standard, color plane) |
| | Sample Info for database |
| | Default size of ROI |
| View | Full set of results |
| | Full image size |
| | Line reflectance or density profile |
| | Original Image |
| Run | Dot analysis |
| | Line analysis |
| | Area analysis |
| | MTF analysis |
| | TRC analysis |
| Database Setup | New table |
| | Open and close table |
| | View table |
| | Setup table parameters and sample |
| | specifications |
| | Delete table |
| File | Open image |
| | Save image |
| | Save data |
| Setup Program | Setup display order of analysis results |
| | Setup pass/fail tolerance |
| | Setup button |
| | Set default values |
| Database Program | Open and delete tables |
| | View and edit tables |
| | Run analysis by plot and filtering |
| Communication with PC | ActiveSync with laptop or desktop PC |
| Screen capture | |
| Printing | |

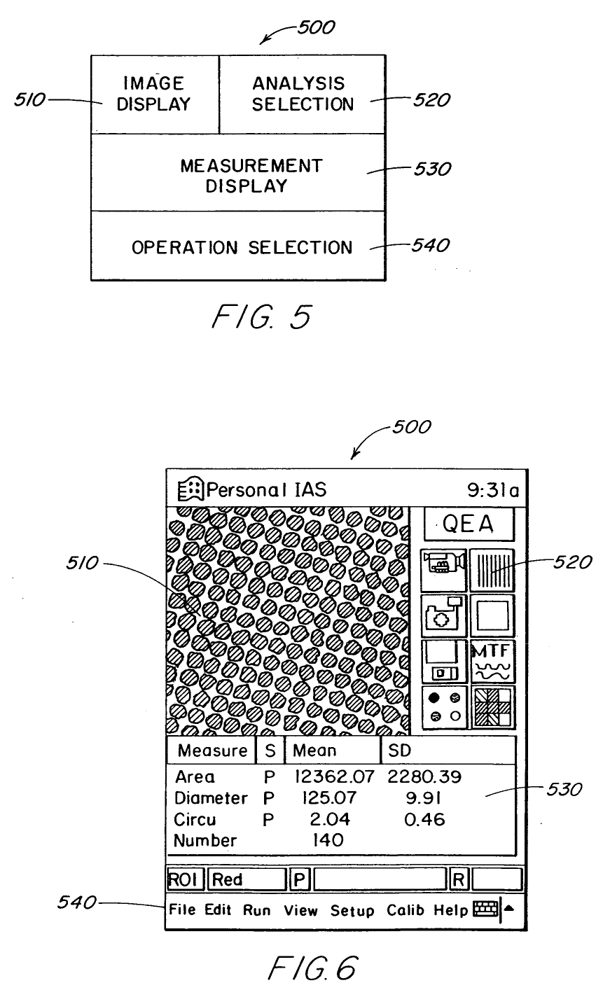

More specifically, FIG. 5 illustrates a configuration of a GUI display for a VSP 500 according to an embodiment of the present invention. The VSP 500 of the present embodiment may include an image display 510, an analysis selection portion 520, a results display 530, and an operation status and selection portion 540. The image display 510 is used for displaying the live or stored image captured by the image capture unit. The analysis selection portion 520 allows basic image quality attributes of the captured image to be analyzed such as dot, line, area, modulation transfer function (MTF), and tone reproduction attributes. The results display 530 provides measurement results from the analysis. Various operations, such as creating and editing files, setting up and customizing analyses, calibrating analyses and other functions, are initiated from the operation selection portion 540. The GUI display may be configured for being selectively activated in a variety of manners such as by a touch screen or a voice activated mechanism. More specifically, an exemplary GUI display for capturing and analyzing an image is shown in FIG. 6 in use.

An integrated and reconfigurable multi-function system is provided by designing the VSP 500 to include software having the necessary analysis, measurement and display tools for evaluating the image. Initially, the software is launched by selecting (tapping) a button or icon on the GUI of the VSP 500 which represents this feature. Once the software is launched, the GUI desktop screen is displayed having a configuration as shown in the embodiment of FIGS. 5 or 6. To begin an analysis, a live button or icon is selected from the analysis selection portion 520 and the live image from the image capture unit is displayed on the image display 510. A region of interest (ROI) of the displayed live image may be then selected from any portion of the live image. This is preferably accomplished-by using a stylus to draw a box around the ROI on the GUI. Upon defining the ROI, one of the analysis applications may be selected from the analysis selection portion 520. After selecting a ROI, a portion of the initial ROI can be expanded by zooming electronically to the desired portion to be analyzed in more detail.

Some exemplary analyses that may be performed are shown in Table II. The details for conducting some of these exemplary analyses follow.

TABLE II

| Tool | Attributes/Features/Functions |
|---|---|
| Method/Design | ROI-based analysis on captured image |
| | ROI-based analysis on saved image |
| | Two-point distance measurements |
| | Local gray scale value |
| | Factory set or user selectable magnification |
| | Transmission/Reflection |
| | Narrow or broadband illumination; continuous or |
| | stroboscopic illumination |
| Dot | Absolute or relative thresholding |
| | Statistically based dot thresholding |
| | Multiple dot statistics |
| | Histogram |
| | Positive or negative dots (voids) |
| | Dot contour |
| | Dot profile |
| | Area |
| | Equivalent circle diameter (ECD) |
| | Perimeter length |
| | Circularity |
| | Aspect Ratio |
| | Orientation |
| | x-y location |
| | Displacement |
| | Density |
| | Color—Lab (Illuminant, observers) |
| | Dot % |
| | Line Screen (Lines/cm or Lines/inch) |
| | Screen angle |
| | Satellites |
| | Background (% Area, RMSGS in CMYK) |
| | Slur and doubling |
| | Chip skew (inkjet printhead) |
| Line | Adaptive thresholding (ISO-13660) |
| | Multiple line statistics |
| | Positive or negative lines |
| | Edge contour (60%) |
| | Width (also, text stroke width) |
| | Blurriness (leading edge, LE, and trailing edge, TE) |
| | Raggedness (LE, TE) |
| | Reflectance and density |
| | Reflectance and density profile (RGB) |
| | Density (Status A, T, Din, DinNB) |
| | Color—L*a*b* |
| | Contrast |
| | Fill (voids, deletions) |
| | Orientation |
| | No. of line breaks |
| | Modulation transfer function (MTF) |
| | Intercolor bleed |
| | LE and TE locations |
| | Distance between two lines |
| | Color registration |
| Area | Histogram |
| | Density/Reflectance |
| | Density difference |
| | Area coverage, dot percentage (in TRC) |
| | Dot gain (Murray-Davies and Yule Nielsen) |
| | Tone reproduction |
| | Ink trap |
| | Print contrast |
| | Gray balance |
| | Graininess |
| | Mottle |
| | Color—L*a*b* |
| | ΔE and ΔD |
| | Gloss |
| | Print through |
| Motion | Paper motion |
| | Print head motion |
| | Mechanism jitter |
| Other Functions | OCR |
| | 1D and 2D barcode |
| | Digital watermark |
| | Whiteness |
| | Brightness |
| | Yellowness |
| | Tint |
| | Fluorescence analysis |
| | Data logging |
| | Statistical quality control |
| | Time series and control charts |

In a dot quality analysis (also referred to as blob analysis) according to an embodiment of the present invention, the size and shape of a single dot or the same attributes for a cluster of dots are evaluated. Because a dot is the most basic building block in digital and conventional printing, dot analysis is fundamental in analyzing image quality. The size, shape, and distribution of a cluster of dots ultimately determine the appearance of an image to a viewer in terms of details, uniformity, and color. The dot quality analysis according to the present embodiment reports the size and shape of dots so that this information may be used to quantitatively evaluate the dot quality of images from different printers, inks, print media, printing technologies and the like. Objective pass/fail decisions may also be performed with user-specified acceptance levels as defined in the operation selection portion 540, which will be discussed in more detail below.

The dot quality analysis may also analyze other image quality attributes such as satellites or extraneous marks around dots and lines, toner background analysis, voids analysis, text quality and print defects in inkjet printing or electrophotography for example. According to the application of the analysis, the software is selectively customized by the operation selection portion 540.

In conducting the dot quality analysis, default parameters may be pre-set in the software for defining typical dot parameters upon which the dot will be analyzed. For example, dot analysis defaults may be set for threshold analysis (the reflectance range defining the edge of a dot) at 50%, minimum and maximum dot diameter at 10 μm and 100 μm, and dark dots analysis (as opposed to light dots or voids in a solid area being analyzed). Other dot parameters may be set to obtain different desired information. For instance, the threshold analysis may be changed to accommodate extreme dot density and contrast with the surrounding, the size may be adjusted to exclude satellites at the edge of dots or lines from the analysis, the analysis may be set to focus only on satellites, the void analysis may use light dots instead of particles, and/or the analysis may set pass/fail acceptance levels.

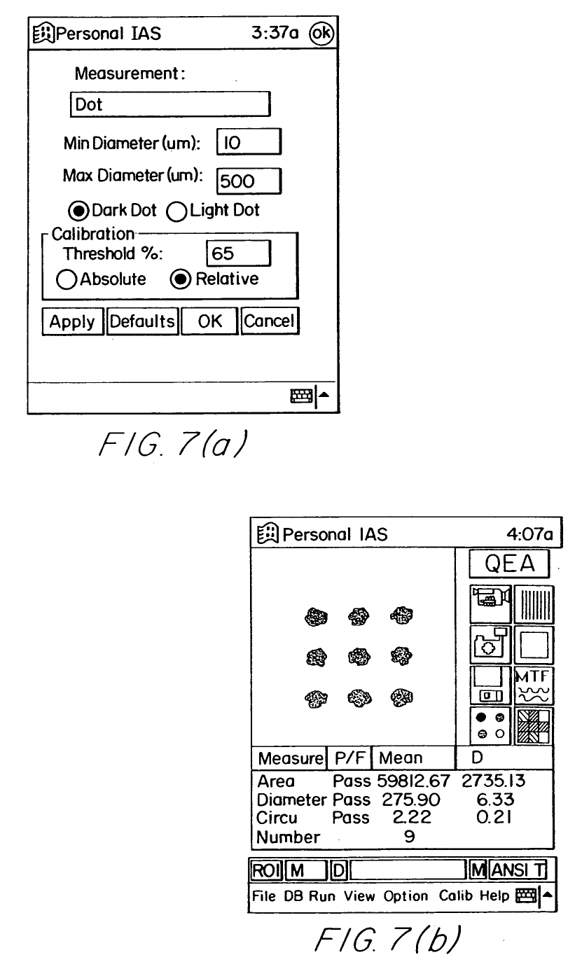

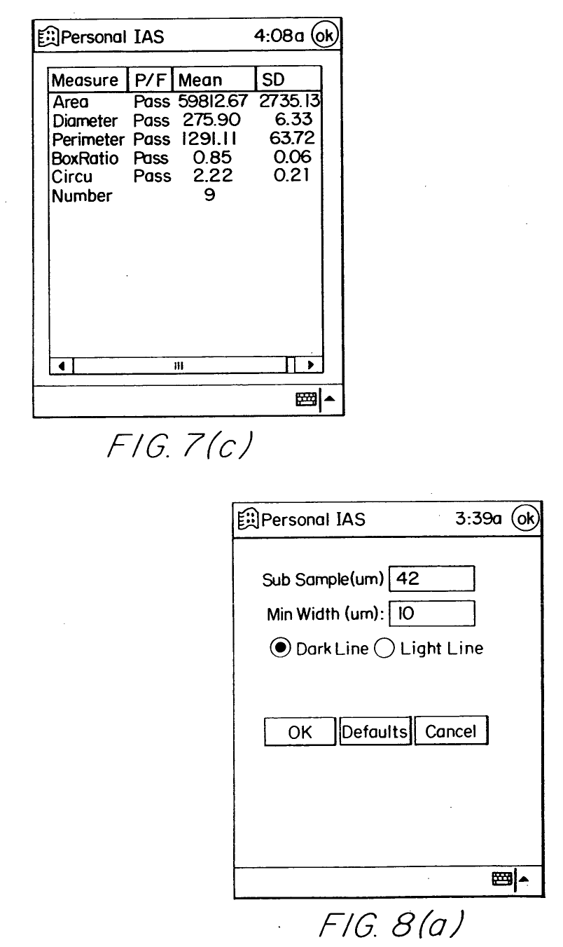

The dot parameter customization is performed by selecting a setup button or icon from the operation selection portion 540 and tapping on a setup dot parameter indicator. The desired parameter settings may be selected and adjusted from the provided options as shown in FIG. 7(a) for one example. A specific color plane in which the dots are analyzed can also be selected from the operation selection portion 540. Once the analysis is set up, the image capture unit is positioned over the desired image and then the ROI is identified. Next, the dot analysis button or icon is selected from the analysis selection portion 520, and the measurement results from the dot quality analysis are displayed on the measurement results display 530. Typically, the mean and standard deviation of the area and diameter of an equivalent circle of the dots, the circularity of the dots found (equaling one for a perfect circle or a different value for irregular dots), and the total number of dots within the ROI are displayed as shown by one example in FIG. 7(b). Other analysis results can be displayed as illustrated in FIG. 7(c) in place of the above parameters by selecting them accordingly in a companion setup program. Also, the pass/fail results may be displayed when the analysis has been customized to perform in such a manner.

A line quality analysis performed in another embodiment of the present invention evaluates the image quality attributes such as the width and sharpness of a single line or a group of lines. Because a line is a basic building block for graphics, text and image elements, line analysis is another fundamental component of analyzing image quality as the attributes of a line ultimately determine the clarity of an image (sharpness and details). In addition to analyzing the line width, the software analyzes other attributes such as blurriness, raggedness, contrast, fill, and darkness. With this information, images from various printers, inks, print media, printing technologies and the like may be quantitatively evaluated for their line quality. Also, objective pass/fail decisions may be performed with user-specified acceptance levels as defined in the operation selection portion 540 as discussed above in the dot quality analysis section.

The line quality analysis may be used to evaluate the amount of line bleed or growth (the “bleeding” of ink over the expected line edge) and intercolor bleeding (one ink bleeding into another on a multi-color print) and determine the performance of a printer, the quality of paper and the legibility of fine image details. Other applications of the line quality analysis may include modulation (resolution) measurements and color registration using black and colored lines. Based on the application of the analysis, the software is selectively customized for the analysis in the operation selection portion 540.

In conducting the line quality analysis, default parameters may be pre-set in the software for defining typical line parameters upon which the line analysis is performed. For example, line analysis defaults may be set for a sub-sample (the distance which is averaged along the length of the line to smooth the line edge) at 42 μm, for a minimum analyzed line width of 10 μm, and for a dark lines analysis (as opposed to light lines in a solid background analysis). The color plane in which the line quality analysis is performed can also be specified. Other line parameters may be set to obtain different desired information. For instance, the sub-sample may be changed to allow detection of every edge variation, the width may be adjusted to exclude thinner lines that are not of interest, and/or light (or negative) lines may be analyzed on a solid background.

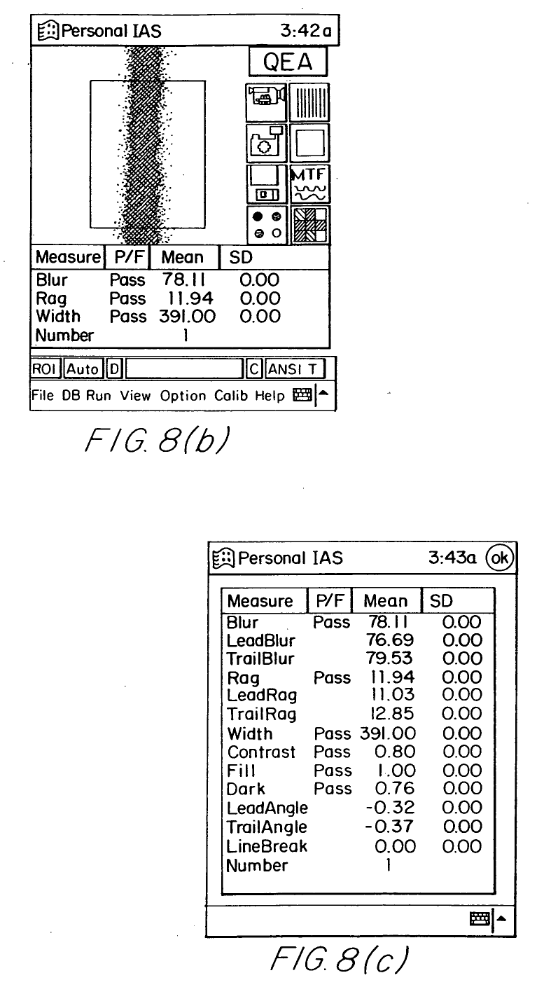

The line parameter customization is performed by selecting a setup button or icon from the operation selection portion 540 as in the dot parameter customization and tapping on a setup line parameter indicator. The desired parameter settings may be selected and adjusted from the provided options as shown for one example in FIG. 8(a). Once the analysis is set up, the image capture unit is positioned over the desired image and then the ROI is identified. Next, the line analysis button or icon is selected from the analysis selection portion 520 and the measurement results from the line quality analysis are displayed on the measurement results display 540 as shown by example in FIG. 8(b). Typically, the mean and standard deviation of the blurriness (edge sharpness), raggedness (edge roughness) and width of the lines within the ROI are displayed while other parameters can also be displayed when specified in the companion setup program. Also, the pass/fail results are displayed when the analysis has been customized to perform in such a manner. Additional results may also be displayed on a greater portion of the VSP 500 by selecting a view button in the operation selection portion 540 and selecting a view results feature. The additional results that may be displayed include contrast (the difference between the background and the line reflectance), fill (equals one for a perfectly filled line or less for a broken line or a line with voids), and darkness (density) of the line, number of broken segments in a line, and various other results as shown by example in FIG. 8(c).

In another embodiment of the present invention, an area quality analysis is performed which evaluates the density, reflectance and their variations expressed in terms of graininess and mottle across a region. Because obtaining a uniform area of controllable density is important in producing pictorial images and accurate graphical reproductions, analyzing the density, reflectance, and their variations across a region are critical to determine the tonal quality of an image. Other factors such as graininess and mottle may be used for determining the quality of ink distribution over an area. Further, the color of the measured area is also reported in terms of luminance, saturation and hue (or in terms of L*, a* and b*). With this information, images from various printers, inks, print media, printing technologies and the like may be quantitatively evaluated for their area quality. Also, objective pass/fail decisions may also be performed with user-specified acceptance levels from the operation selection portion 540 as previously discussed above.

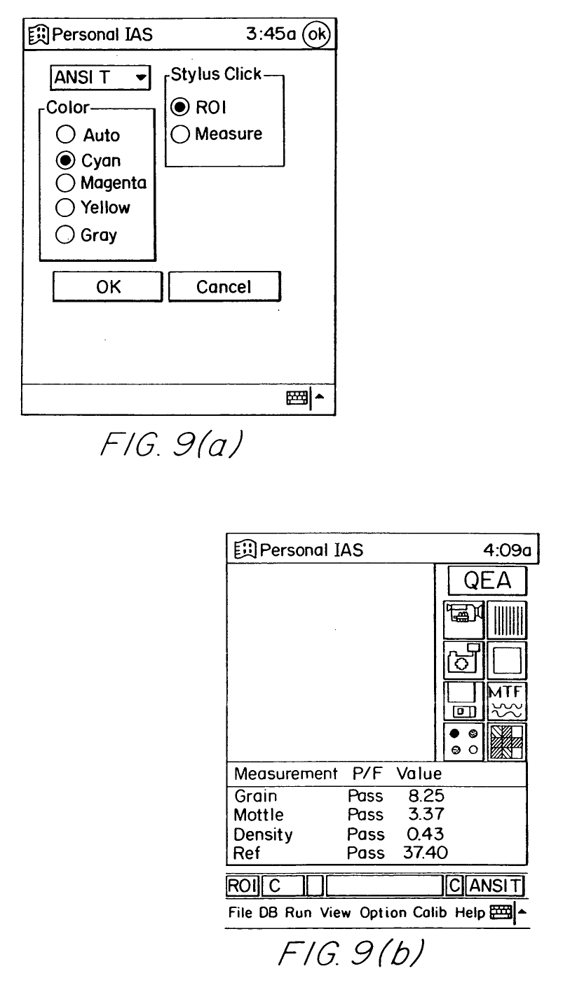

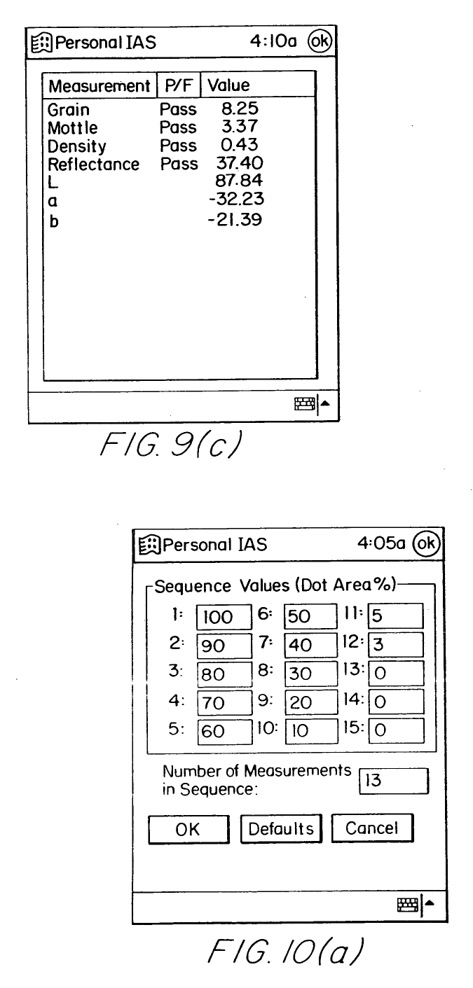

The area quality analysis may also be used to evaluate coalescence, which commonly occurs in inkjet printing, by quantifying the mottle or graininess. Other applications of the area quality analysis may include ink print-through or the amount of soak through to the other side of the paper, whiteness, brightness, smoothness, glossiness, and paper “dirt count” or graininess. Based on the application of the analysis, the software is selectively customized for the analysis in the operation selection portion 540 or in the companion setup program. In conducting the area quality analysis, default parameters may be pre-set in the software for defining typical area parameters upon which the area analysis is performed. Desired parameter settings may be selected and adjusted from predetermined options as shown by example in FIG. 9(a).

Once the area analysis is set up, the image capture unit is positioned over the desired image and the ROI is identified. Next, the line analysis button or icon is selected from the analysis selection portion 520 and the measurement results from the line quality analysis are displayed on the measurement display 540 as shown by example in FIG. 9(b). Typically, graininess (the high frequency reflectance or density variations), mottle (low frequency reflectance or density variations), density (the amount of light absorbed by the surface in the field of view (FOV)), and reflectance (the amount of light reflected off the surface in the FOV), and the color of the measured area are displayed as shown for example in FIG. 9(c) while other parameters can also be displayed by selection in the companion setup program. Also, pass/fail acceptance levels may be displayed if the analysis has been programmed in such a manner.

A tone reproduction analysis performed in another embodiment of the present invention measures a range of densities to evaluate the overall shape of the tone reproduction curve. Such information relating to control over print density and tone reproduction (the ability to accurately reproduce densities and differentiate fine density levels) is important in determining high quality pictorial images having fine highlight and shadow areas. Optimizing the control over print density and tone reproduction enhances pictorial image qualities such as fine details in highlight and shadow areas. In addition to analyzing the print density and tone reproduction, the software analyzes other attributes that determine the quality of tone reproduction such as reflectance, density, area coverage, dot gain, graininess and mottle. With this information, images from various printers, inks, print media, printing technologies and the like may be quantitatively evaluated for their tone reproduction. The tone reproduction analysis may also evaluate different ink sets to different paper, and to the interaction between the ink and paper. Measurements from the tone reproduction analysis may be further used to generate dot gain curves and area coverage curves for printing applications and evaluating image nose across different densities. Also, objective pass/fail decisions may also be performed with user-specified acceptance levels as defined in the operation selection portion 540 as previously discussed.

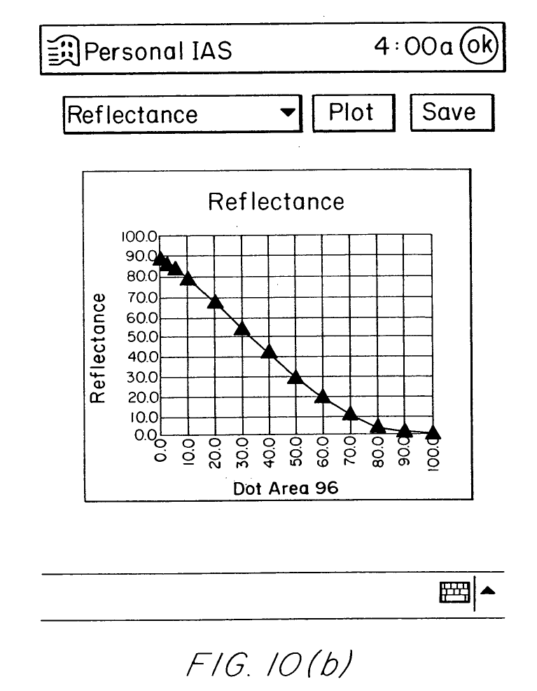

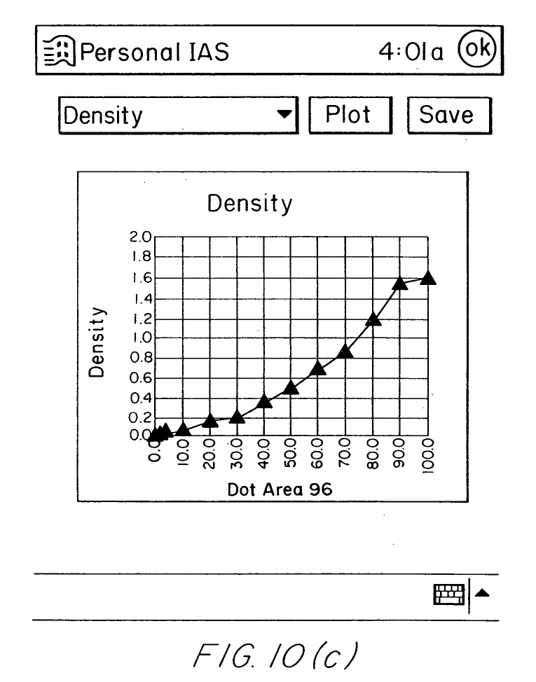

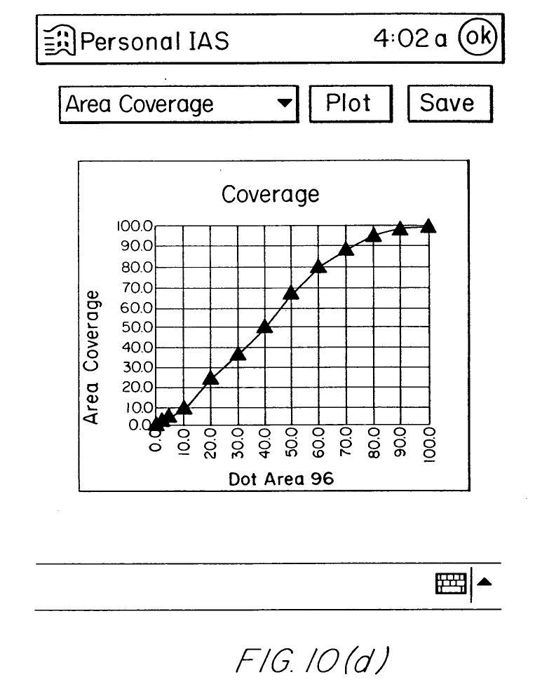

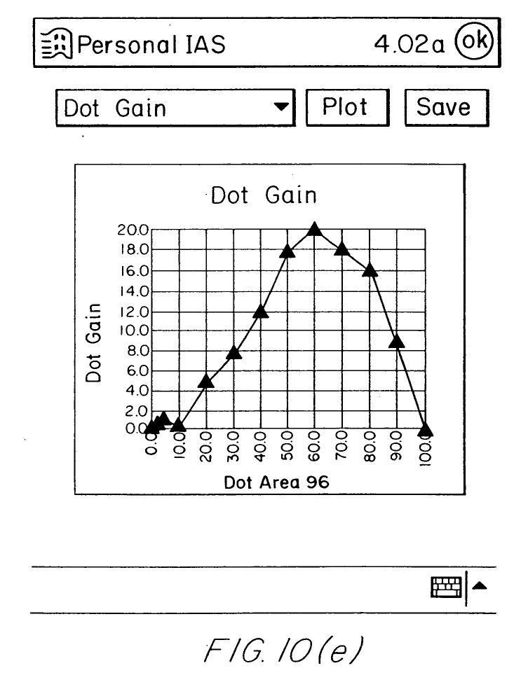

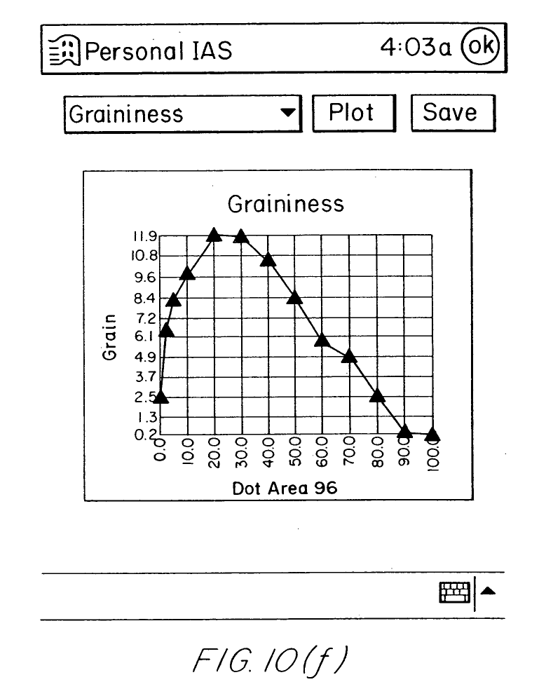

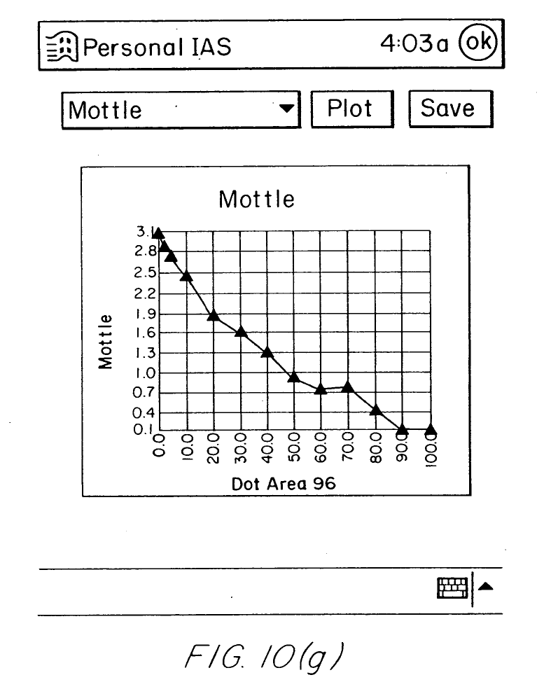

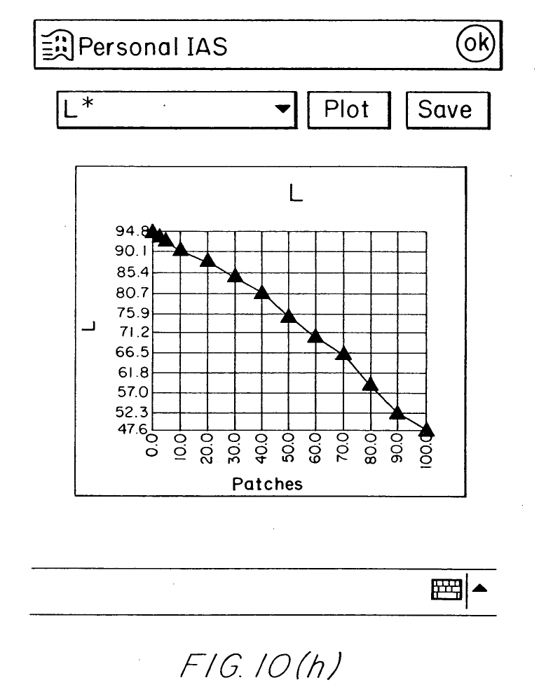

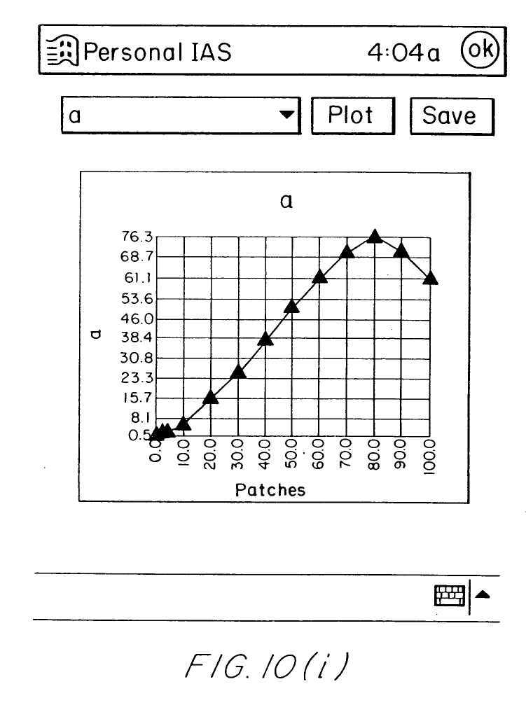

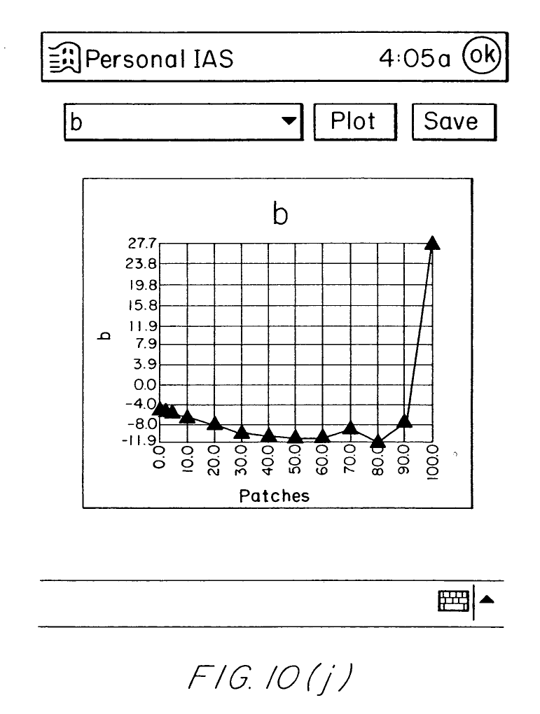

In conducting the tone reproduction analysis, default parameters may be pre-set in the software for conducting typical tone reproduction analysis. For example, a tone parameter, which defines the input value to create the printed tone reproduction ramp, is specified as the tint percentage for a set of patches. The tone reproduction parameters are set by selecting a setup button or icon from the operation selection portion 540 as previously described and then tapping on a setup tone parameters indicator. The desired parameter settings may be selected and adjusted from the provided options as shown in FIG. 10(a). Once the analysis is set up, the image capture unit is positioned along the tone reproduction ramp for each of the patches. Next, the tone reproduction analysis button or icon is selected from the analysis selection portion 520 and the measurement results from the tone reproduction analysis are displayed on the measurement display 540. In default mode, a graph of reflectance v. dot area percentage is displayed as shown in FIG. 10(b). Additional graphs such as density and area coverage (from the Murray-Davies equation for APA) as shown in FIGS. 10(c) and 10(d), dot gain (from the Murray-Davies equation) as shown in FIG. 10(e), graininess as shown in FIG. 10(f), mottle as shown in FIG. 10(g), and color information such as L*, a*, and b* as shown in FIGS. 10(h), 10(i) and 10(j) may be selected for display.

A modulation transfer function (MTF) analysis performed in another embodiment of the present invention measures a range of line spacing densities to evaluate the MTF or contrast transfer function s to quantify a print system's ability to reproduce fine spatial details. Optimizing the control over spatial fine details enhances pictorial image qualities such as sharp lines, sharp edge and fine details.

All of the analysis functions compile data for each of the tests. During set up, the particular analysis may be configured to display only the data of interest. A set up for an application can be stored for repeated use. Various analysis customization may be set up and reconfigured, such as the display of data order, the data tolerance, the presented analysis buttons or icons in the analysis selection portion, database options, and the default values in the companion setup program.

The image analyzing system according to the embodiments of the present invention may be used in many different applications which require various specialized image capture unit attachments. For instance, electrostatic imaging or magnetic imaging devices may be used for sampling images as the image capture unit.

In another example of an application for the image analyzing instrument, forensic and medical analysis may be performed. In such analyses it is important to control and adjust the depth at which the sample is viewed. Accordingly, an oil interface/coupling may be used in conjunction with the image capture unit. Some applications for this embodiment may include fingerprint and dermatology evaluations.

In yet another example of an application for the image analyzing instrument, 1D or 2D barcodes analysis and watermark analysis may be performed. Also, stereo viewing and processing of a sampled image may be performed in still another application of the image analyzing instrument. For instance, stereo viewing of printed circuit boards and flat panel displays may be analyzed for defects.

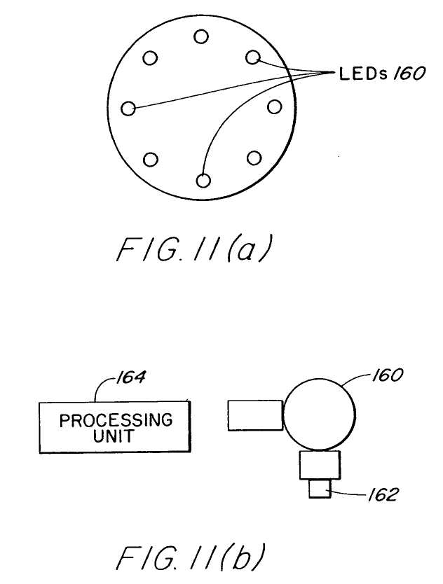

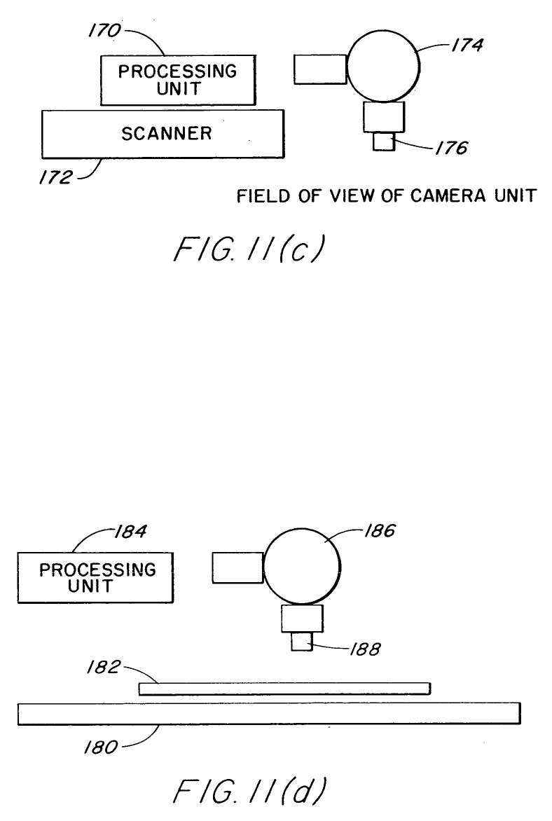

Another example of the present invention further includes the provision of multiple selectable wavelengths of illumination for the field of view so the information on image and illumination wavelength can be correlated in the analysis or viewing where wavelength response of the sample under analysis. For example, several LEDs or LEDs 160 with multiple selectable wavelengths can be used for this purpose as shown in FIG. 11(a). Other light sources may also be used such as ultraviolet (UV) for stimulating fluorescence in some sample materials, infrared (IR) for exciting other material responses, a broadband light source such as a tungsten halogen lamp or a fluorescent lamp, bandpass filters used in conjunction with a broadband light source, flash lamp or LEDs for stroboscopic illumination and various miniature solid state lasers at different wavelengths and power levels.

As a further aspect of the invention, an image capture unit 160 with a close up connection adapter 162 can be provided separately as an add-on shown in FIG. 11(b). Alternatively, the close up connection adapter 162 can be provided as a separate unit from the image capture unit 160.

The VSP unit 170 can be associated with or mounted n a scanner 172 to provide relative motion between the image capture unit 174 and its field of view as shown in FIG. 11(c). Positioning devices, ultrasonic or optic, etc. can be used to give position information to permit analysis along a length of scan, or even an area, bigger than the field of view. Additionally, the LEDs 160 noted above can be replaced by coherent sources so that the system views an interference pattern that can be analyzed for dimension or height data.

The image capture unit can also be coupled to the VSP unit via a USB connection or similar interfaces to allow the camera to function physically separate from the VSP unit. The system can also be used with illumination from a light source below a sample to view transmissive elements such as microscope slides as shown in FIG. 11(d). The system can also be given self calibrating analysis features using reference colors and intensities and test objects. With operator designation of the system seeing a predetermined reference, the system can be calibrated accordingly. Also, it is possible to replace the image capture unit with other forms of sensors to use, for example, in electrostatic or magnetic detection and analysis.

The embodiments of the present invention are directed to systems which advantageously combine the power of a VSP unit, such as a PDA, with an image capture unit, such as a digital camera attachment, to allow for image capture and analysis using on board software. Additional features allow communication with remote sites to transfer data for viewing or more powerful analyzing and to further enable local downloading of information and desired software by the user in the field. Compact and convenient packaging using multi-position supports, mirrors, and devices enhance the portability and handiness of the present invention.

It will be apparent to those skilled in the art that other modifications to and variations of the above-described techniques are possible without departing from the inventive concepts disclosed herein. Accordingly, the invention should be viewed as limited solely by the scope and spirit of the appended claims.

What is claimed is:

1. A portable image analyzing system, comprising:
an image capture unit for capturing images of a sample within a field of view;
a miniaturized processor operatively communicative with said image capture-unit for receiving the image therefrom and analyzing features of the image for predetermined information obtained from said image; and
a display for displaying the image and analysis results from said miniaturized processor in reconfigurable user defined formats.

2. An image analyzing system according to claim 1, wherein said image capture unit comprises a digital camera.

3. An image analyzing system according to claim 1, wherein said miniaturized processor comprises a personal digital assistant.

4. An image analyzing system according to claim 1, wherein said image capture unit and said miniaturized processor are physically integrated.

5. An image analyzing system according to claim 4, further comprising a housing for said image capture unit and said miniaturized processor.

6. An image analyzing system according to claim 1, wherein said image capture unit, said miniaturized processor and said display are optically communicative but physically separate.

7. An image analyzing system according to claim 1, wherein said image capture unit, said miniaturized processor and said display are electrically communicative but physically separate.

8. An image analyzing system according to claim 1, further comprising an optics and illumination unit.

9. An image analyzing system according to claim 8, wherein said optics and illumination unit comprises a fixed focus or variable magnification lens.

10. An image analyzing system according to claim 8, wherein said image capture unit comprises said optics and illumination unit.

11. An image analyzing system according to claim 8, wherein said optics and illumination unit comprises a narrow band or a broadband illumination source for selecting the spectral content thereof from ultraviolet (UV), visible light, and infrared (IR).

12. An image analyzing system according to claim 8, wherein said optics and illumination unit comprises a reflective illumination source that is arranged for reflecting light from the sample to-be captured and analyzed.

13. An image analyzing system according to claim 8, wherein said optics and illumination unit comprises a transmissive illumination source that is arranged for transmitting light from the sample to be captured and analyzed.

14. An image analyzing system according to claim 8, wherein said optics and illumination unit comprises a switch for turning off an illumination source for analyzing an emissive sample.

15. An image analyzing system according to claim 8, wherein said optics and illumination unit comprises a controllable flash or stroboscopic illumination source.

16. An image analyzing system according to claim 8, wherein said optics and illumination unit comprises lens and an array or light sources for focusing and illuminating the sample.

17. An image analyzing system according to claim 1, wherein said miniaturized processor comprises a transport link for transmitting said predetermined information to external devices.

18. An image analyzing system according to claim 17, wherein said transport link comprises a serial link, a universal serial bus (TSB) link, an infrared (IR) link, a compact flash (CF) or comparable solid-state memory card, or a miniature hard disk drive.

19. An image analyzing system according to claim 1, wherein said miniaturized processor comprises a telecommunications link for transmitting said predetermined information to external devices.

20. An image analyzing system according to claim 19, wherein said telecommunications link is a wireless link.

21. An image analyzing system according to claim 1, wherein said miniaturized processor saves and retrieves said predetermined information into a predetermined file format.

22. An image analyzing system according to claim 1, wherein the analysis performed by said miniaturized processor comprises print image analysis, text and graphic analysis, barcode analysis, indicia analysis, watermark analysis, feature and signal analysis, physical surface analysis, and forensic analysis.

23. A method for analyzing samples comprising the steps of:
(a) capturing images of the samples within a field of view;
(b) receiving and analyzing features of the images captured at said step (a) for predetermined information thereof; and
(c) displaying results from the analysis at said step (b) in reconfigurable user defined formats.

24. A method according to claim 24, wherein the analysis performed at said step (b) comprises print image analysis, text and graphic analysis, barcode analysis, indicia analysis, watermark analysis, feature and signature analysis, physical surface analysis, and forensic analysis.
